(19) United States
(12) Patent Application Publication
(10) Pub. No.: US 2013/0233354 A1
(43) Pub. Date: Sep. 12, 2013

(54) SUBSTRATE TREATING APPARATUS AND SUBSTRATE TREATING METHOD

(71) Applicant: DAINIPPON SCREEN MFG. CO., LTD., Kyoto (JP)

(72) Inventor: Takemitsu MIURA, Kyoto-shi (JP)

(73) Assignee: DAINIPPON SCREEN MFG. CO., LTD., Kyoto (JP)

(21) Appl. No.: 13/777,156

(22) Filed: Feb. 26, 2013

(30) Foreign Application Priority Data
Mar. 8, 2012 (JP) JP2012-051880

(51) Int. Cl. B08B 3/04

(52) U.S. Cl. CPC B08B 3/04
USPC 134/29; 134/94.1

(57) ABSTRACT

A substrate treating apparatus for treating substrates by immersing the substrates in a treating solution includes the following elements. A treating tank for storing the treating solution; a lifter capable of supporting a plurality of substrates, and vertically movable between an upper withdrawn position above the treating tank and a treating position inside the treating tank; a treating solution supply device for supplying the treating solution to the treating tank; a dripping device for dripping a surfactant to a surface of the treating solution stored in the treating tank; and a control device for causing the treating solution supply device to supply the treating solution to the treating tank, causing the lifter to place the substrates in the treating position, and causing the dripping device to drip the surfactant when raising the lifter to the upper withdrawn position after treatment of the substrates with the treating solution.

### BACKGROUND OF THE INVENTION

(1) Field of the Invention

This invention relates to a substrate treating apparatus and substrate treating method for treating, with a treating solution, semiconductor wafers, substrates for liquid crystal displays, substrates for plasma displays, substrates for organic EL displays, substrates for FEDs (Field Emission Displays), substrates for optical displays, substrates for magnetic disks, substrate for magnet-optical disks, substrates for photomasks and substrates for solar cells (hereinafter called simply substrates). More particularly, the invention relates to a technique of immersing substrates in a treating solution for treatment.

(2) Description of the Related Art

Conventionally, this type of apparatus includes an inner tank, an outer tank, a deionized water feed pipe and an additive feed pipe. See Japanese Unexamined Patent Publication H11-265867, for example. The inner tank receives deionized water from deionized water feed pipe, and a surfactant from the additive feed pipe. Deionized water overflowing the inner tank is collected by the outer tank.

The substrate treating apparatus constructed as above performs cleaning treatment of substrates by immersing the substrates in the deionized water, with the surfactant added thereto, stored in the inner tank. The surfactant added to the deionized water improves wettability of the substrates, thereby to inhibit particles separated from the substrates from re-adhering to the substrates.

However, the conventional example with such construction has the following problems.

Since the conventional apparatus treats substrates with the treating liquid to which a surfactant has been added, an accumulation of the surfactant makes concentration control of the treating liquid difficult. This gives rise to a problem of large variations in the finish of the substrates.

Particles and the like separated from the substrates are discharged by liquid currents from the inner tank to the outer tank, but part of the particles float and stagnate on the liquid surface instead of being discharged completely. Therefore, there also arises a problem that, when the substrates are withdrawn up from the inner tank, the substrates can be contaminated by the particles on the liquid surface.

### SUMMARY OF THE INVENTION

This invention has been made having regard to the state of the art noted above, and its object is to provide a substrate treating apparatus and substrate treating method which, while using a surfactant, can cause little variations in finish and prevent contamination by particles afloat on the surface of a treating solution.

The above object is fulfilled, according to this invention, by a substrate treating apparatus for treating substrates by immersing the substrates in a treating solution, comprising a treating tank for storing the treating solution; a lifter capable of supporting a plurality of substrates, and vertically movable between an upper withdrawn position above the treating tank and a treating position inside the treating tank; a treating solution supply device for supplying the treating solution to the treating tank; a dripping device for dripping a surfactant to a surface of the treating solution stored in the treating tank; and a control device for causing the treating solution supply device to supply the treating solution to the treating tank, causing the lifter to place the substrates in the treating position, and causing the dripping device to drip the surfactant when raising the lifter to the upper withdrawn position after treatment of the substrates with the treating solution.

According to this invention, the control device causes the treating solution supply device to supply the treating solution to the treating tank, and causes the lifter to place the substrates in the treating position, to treat the substrates with the treating solution. Most of particles thereby separated from the substrates are discharged from the treating tank, but part of the particles remain afloat on the surface of the treating solution. Subsequently, when raising the lifter to the upper withdrawn position, the control device causes the dripping device to drip the surfactant to the surface of the treating solution. Consequently, the surface of the treating solution has areas of surface tension lowered by the dripped surfactant, and the other areas of surface tension remaining high. Under a surface diffusion action, the particles are drawn to the areas of higher surface tension to be discharged out of the treating tank. Subsequently, the substrates are moved up to the upper withdrawn position from the surface of the treating solution with the particles substantially removed therefrom. This can prevent contamination of the substrates by the particles afloat on the surface of the treating solution. Since the surfactant is dripped only before raising of the substrates, the surfactant will hardly affect the treatment with the treating solution, and can lessen variations in the finish.

In this invention, the control device may be arranged, after beginning to raise the lifter from the treating position, to stop ascent of the lifter and to cause the dripping device to drip the surfactant when upper edges of the substrates are exposed by a predetermined height from the surface of the treating solution.

Since the upper edges of the substrates produce a flow straightening action, the surfactant dripped can spread in predetermined directions. Thus, the particles can be discharged efficiently by the surface diffusion action.

In this invention, the control device may be arranged, after the surfactant is dripped, to lower the lifter to immerse the upper edges of the substrates exposed from the surface of the treating solution, under the surface of the treating solution again, and thereafter to raise the lifter to the upper withdrawn position.

There is a possibility that the particles and surfactant remain adhering to the upper edges of the substrates, and such particles and surfactant can be removed by once lowering the upper edges under the surface of the treating solution. Raising and lowering under the solution surface may be repeated a plurality of times.

In this invention, the control device may be arranged to cause the dripping device to drip the surfactant before the lifter is raised to expose upper edges of the substrates from the surface of the treating solution.

The surfactant dripped before the substrates begin to be exposed from the surface of the treating solution produces a surface diffusion action, thereby to discharge the particles afloat on the surface of the treating solution.

In this invention, the dripping device may include a nozzle body extending in an aligning direction of the substrates supported by the lifter, and located in central parts of the substrates in a direction perpendicular to the aligning direction, and discharge openings formed in a lower surface of the nozzle body for dripping the surfactant between the substrates.

By dripping the surfactant from the discharge openings of the nozzle body, the surfactant can be dripped between the substrates and to the central parts on the surfaces of the substrates. Therefore, the surface diffusion action can be produced evenly in areas in which the substrates are located. As a result, the particles can be discharged evenly from the areas of the substrates.

In this invention, the dripping device may include a nozzle body having a discharge opening located centrally of an entire surface of the treating solution stored in the treating tank.

The surfactant dripped centrally of the entire surface of the treating solution produces a surface diffusion action in form of concentric circles from the central part in directions of discharge of the treating solution, thereby to discharge the particles afloat on the surface of the treating solution.

In this invention, the substrate treating apparatus may further comprise a heating device for heating the treating solution; wherein the dripping device drips the surfactant having a boiling point lower than a temperature of the treating solution heated by the heating device.

After producing the surface diffusion action, the surfactant is evaporated in a short time by the heat of the treating solution heated by the heating device. Therefore, the concentration of the treating solution is not affected.

In this invention, the dripping device may drip the surfactant consisting of a straight chain alcohol.

The surfactant in this invention, preferably, does not react with the treating solution in order not to impart an adverse influence on treatment, has a boiling point slightly lower than the temperature of the treating solution in order not to accumulate in the treating solution, and has a large difference in surface tension to the treating solution to be advantageous in operating speed and linear stability with respect to particles. To satisfy these conditions, a preferred surfactant is a straight chain alcohol having atoms other than hydrogen atoms linked continuously without branching off.

In another aspect of the invention, a substrate treating method for treating substrates by immersing the substrates in a treating solution, comprises a treating step for immersing the substrates in the treating solution by moving a lifter supporting a plurality of substrates from an upper withdrawn position above a treating tank storing the treating solution to a treating position inside the treating tank; and a dripping step for dripping a surfactant to a surface of the treating solution stored in the treating tank when raising the lifter from the treating position to the upper withdrawn position.

According to this invention, the treating step is executed to move the lifter to the treating position in the treating tank storing the treating solution, to treat the substrates. Next, when raising the lifter to the upper withdrawn position, the dripping step is executed to drip the surfactant to the surface of the treating solution. Consequently, the surface of the treating solution has areas of surface tension lowered by the dripped surfactant, and the other areas of surface tension remaining high. Under a surface diffusion action, the particles are drawn to the areas of higher surface tension to be discharged out of the treating tank. Subsequently, the substrates are moved up to the upper withdrawn position from the surface of the treating solution with the particles substantially removed therefrom. This can prevent contamination of the substrates by particles afloat on the surface of the treating solution. Since the surfactant is dripped only before raising of the substrates, the surfactant will hardly affect the treatment with the treating solution, and can lessen variations in the finish.

### BRIEF DESCRIPTION OF THE DRAWINGS

For the purpose of illustrating the invention, there are shown in the drawings several forms which are presently preferred, it being understood, however, that the invention is not limited to the precise arrangement and instrumentalities shown.

FIG. 1 is a block diagram showing an outline construction of a substrate treating apparatus according to this invention;

FIG. 2 is a plan view of a drip nozzle;

FIG. 3 is a time chart showing operation of the substrate treating apparatus;

FIG. 4 is a schematic view showing a state before treatment;

FIG. 5 is a schematic view showing a state during treatment;

FIG. 6 is a schematic view showing a state of ascent to a minute projection position;

FIG. 7 is an explanatory view of the minute projection position;

FIG. 8 is a schematic view showing a dripping state;

FIG. 9 is a schematic view illustrating a surface diffusion action;

FIG. 10 is a schematic view showing a raising state;

FIG. 11 is a time chart showing a modified operation;

FIG. 12 is a plan view showing a modified drip nozzle;

FIG. 13 is a time chart shows operation when the modified drip nozzle is used; and

FIG. 14 is a schematic view illustrating a surface diffusion action.

### DESCRIPTION OF THE PREFERRED EMBODIMENTS

An embodiment of this invention will be described hereinafter with reference to the drawings.

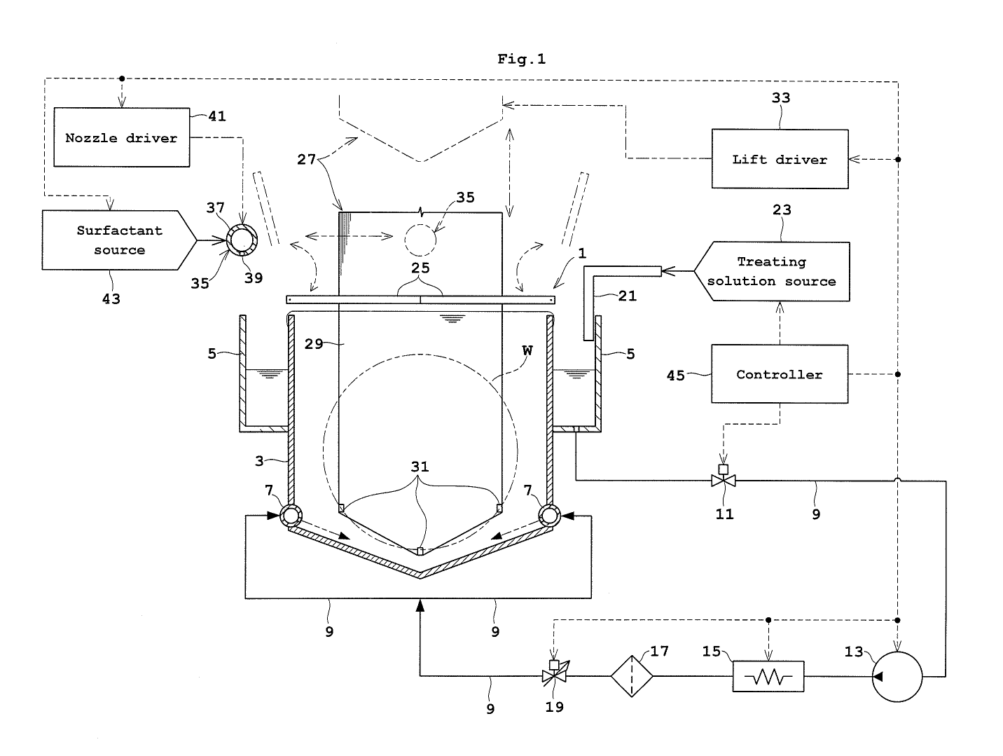

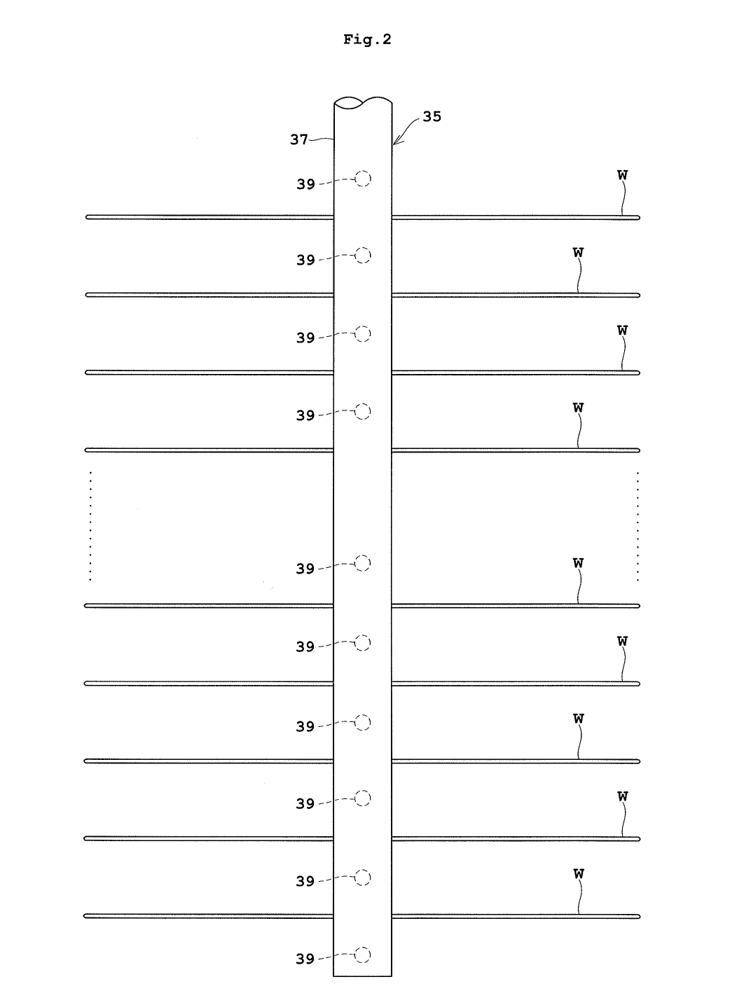

FIG. 1 is a block diagram showing an outline construction of a substrate treating apparatus according to this invention. FIG. 2 is a plan view of a drip nozzle.

The substrate treating apparatus in this embodiment includes a treating tank 1. This treating tank 1 receives a plurality of wafers W, and stores a treating solution for treating the wafers W. The treating tank 1 has an inner tank 3 and an outer tank 5. The inner tank 3 receives the wafers W aligned in a direction perpendicular to the plane of FIG. 1. The outer tank 5 is formed around an upper portion of the inner tank 3 for collecting the treating solution overflowing the inner tank 3. The inner tank 3 has jet pipes 7 arranged at opposite sides of the bottom thereof, respectively. The pair of jet pipes 7 have one end of circulation piping 9 connected thereto. The other end of the circulation piping 9 is connected to a drain port of the outer tank 5.

The above jet pipes 7 correspond to the “treating solution supply device” in this invention.

The circulation piping 9 has, mounted thereon, a control valve 11, a circulating pump 13, an in-line heater 15, a filter 17 and a flow control valve 19 arranged in order from upstream to downstream. The control valve 11 controls circulation of the treating solution through the circulation piping 9. The circulating pump 13 feeds under pressure the treating solution present in the circulation piping 9. The in-line heater 15 heats the treating solution circulating through the circulation piping 9 to a predetermined treatment temperature. The filter 17 removes particles and the like included in the treating solution circulating through the circulation piping 9. The flow control valve 19 adjusts a flow rate of the treating solution circulating through the circulation piping 9.

A treating solution feed nozzle 21 is provided laterally of the outer tank 5. The treating solution feed nozzle 21 has a discharge end thereof directed to the interior of the outer tank 5. A supply end of the treating solution feed nozzle 21 is connected to a treating solution source 23. In order to supply the treating solution to the treating tank 1, the treating solution is fed to the outer tank 5, and while circulating the treating solution through the circulation piping 9, temperature control is carried out to bring the solution to the treatment temperature, and the treating solution is supplied to the inner tank 3. The treating solution overflowing the inner tank 3 is collected by the outer tank 5, and is circulated through the circulation piping 9 again. The treating solution may be phosphoric acid (H₃PO₄) or SPM (mixture of sulfuric acid and hydrogen peroxide solution), for example. Phosphoric acid is used at a treatment temperature of 160° C., for example. SPM is used at a treatment temperature of 100-150° C., for example.

The inner tank 5 has an auto cover 25 disposed above upper edges thereof. The auto cover 25 separates an upper portion of the inner tank 5 from the ambient atmosphere. The auto cover 25 has horizontal axes adjacent the upper edges of the inner tank 3, to be openable and closable in right and left directions in FIG. 1.

A lifter 27 is disposed above the inner tank 3. The lifter 27 includes a back board 29 extending along an inner wall of the inner tank 3, and support members 31 extending horizontally from lower parts of the back board 29. The support members 31 contact lower edges of the wafers W and support the wafers W in vertical posture. The lifter 27 is vertically movable between an “upper withdrawn position” (shown in a two-dot chain line in FIG. 1) above the inner tank 3 and a “treating position” (shown in a solid line in FIG. 1) inside the inner tank 3. Its vertical movement is caused by a lift driver 33.

A drip nozzle 35 is disposed laterally of the outer tank 5. The drip nozzle 35 includes a nozzle body 37 and a plurality of discharge openings 39. As shown in FIG. 2, the nozzle body 37 assumes the shape of a tube which, in a dripping position, has a long axis extending in the aligning direction of the wafers W and opposed to central parts of the wafers W in the direction perpendicular to the aligning direction. The discharge openings 39 are formed apart from one another in a lower surface of the nozzle body 37, and in the dripping position are set between the wafers W.

The drip nozzle 35 is moved by a nozzle driver 41. Its movement is made between a “standby position” shown in solid lines in FIG. 1 and the “dripping position” shown in two-dot chain lines in FIG. 1.

The drip nozzle 35 is supplied with a surfactant from a surfactant source 43. The surfactant here preferably has a boiling point slightly lower than the temperature of the treating solution. Further, the surfactant preferably fulfills the conditions that it does not react with the treating solution in order not to impart an adverse influence on treatment, that it has a boiling point slightly lower than the temperature of the treating solution in order not to accumulate in the treating solution, and that it has a large difference in surface tension to the treating solution to be advantageous in operating speed and linear stability with respect to particles.

Where the treating solution is phosphoric acid (160° C.) or SPM (150° C.), the following straight chain alcohols are suitable as surfactant. A straight chain alcohol is a compound having atoms other than hydrogen atoms linked continuously without branching off. In the following notations, the figure in parentheses following each surfactant indicates the boiling points of the surfactant.

ethylbenzene (136.19° C.), octane (125.67° C.), o-xylene (144.41° C.), m-xylene (139.10° C.), p-xylene (138.35° C.), diethylene glycol dimethyl ether (159.80° C.), cyclohexane (155.60° C.), ethyl dichloroacetate (156.50° C.), 2,3-dimethyl-2-butanol (118.59° C.), 3,3-dimethyl-2-butanol (120.00° C.), 2,2-dimethyl-1-propanol (113.00° C.), 2,5 dimethylhexane (109.10° C.), toluene (110.63° C.), 1-butanol (117.73° C.), 1-hexanol (157.08° C.), 2-hexanol (139.89° C.), 3-hexanol (135.42° C.), 2-hexanone (127.50° C.), 3-hexanone) (123.20°

The above-noted control valve 11, circulating pump 13, in-line heater 15, flow control valve 19, supply from the treating solution source 23, lift driver 33, nozzle driver 41, and supply from the surfactant source 43 are operable or effected under overall control of a controller 45. The controller 45 has a built-in CPU and memory, and controls the respective components based on a recipe specifying procedures and processing conditions.

The above drip nozzle 35 corresponds to the “dripping device” in this invention. The controller 45 corresponds to the “control device” in this invention.

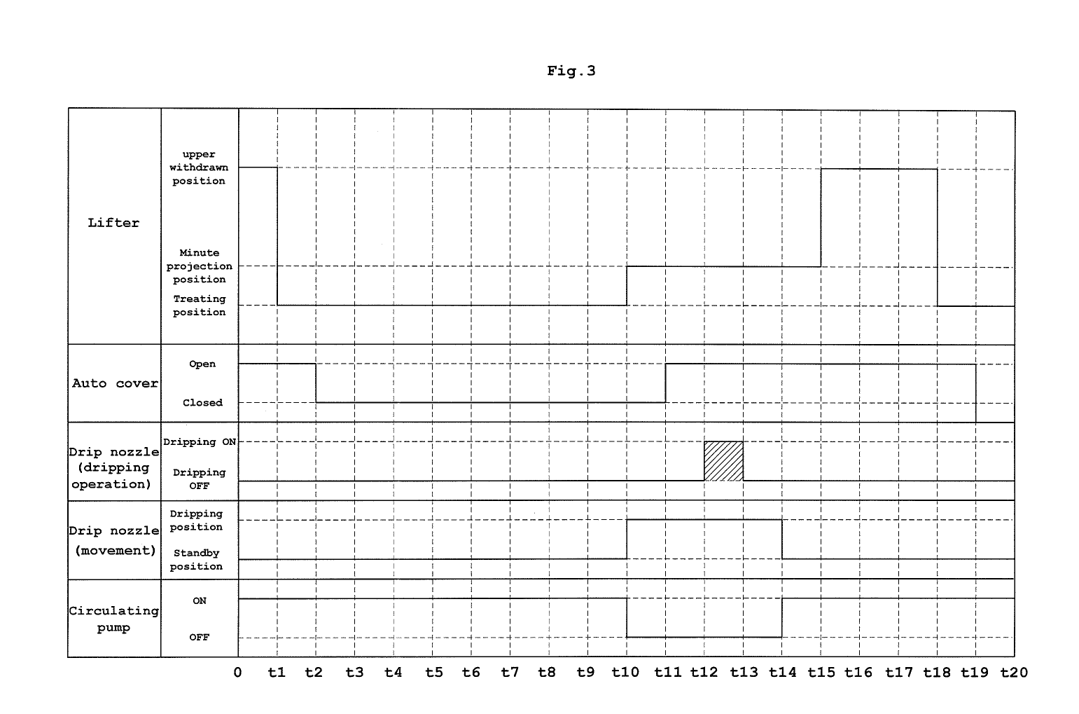

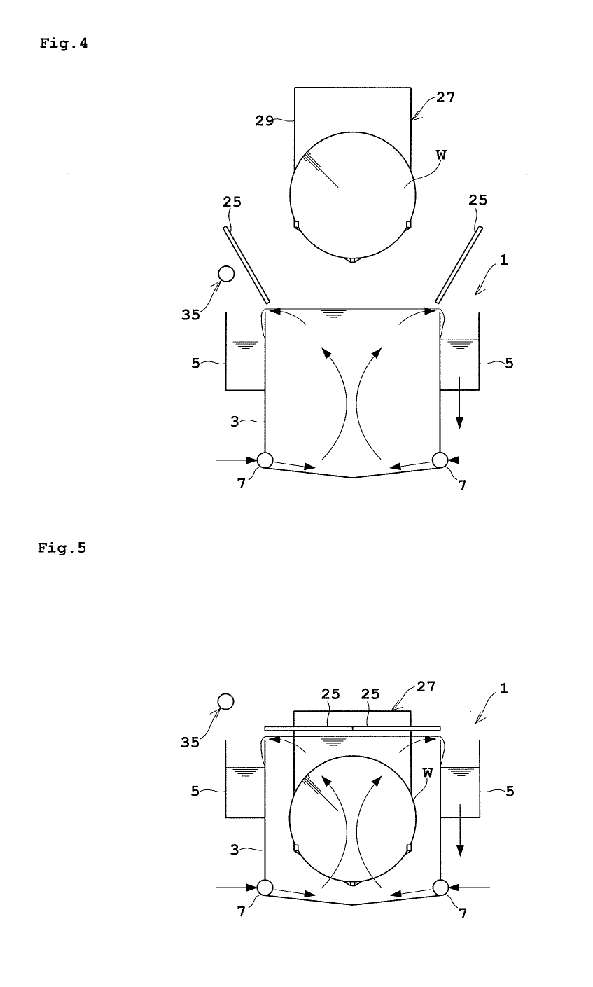

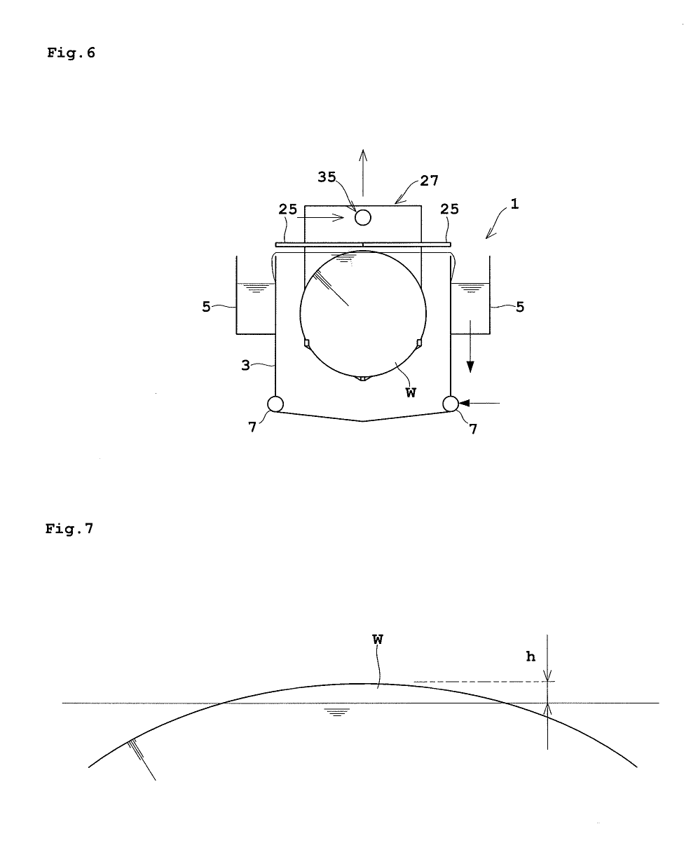

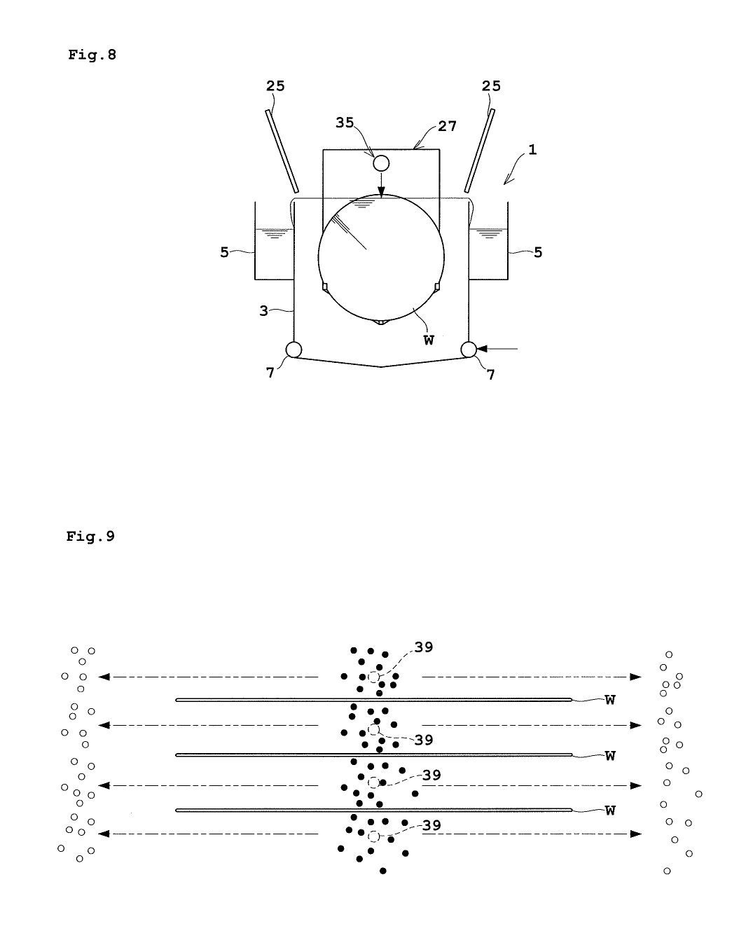

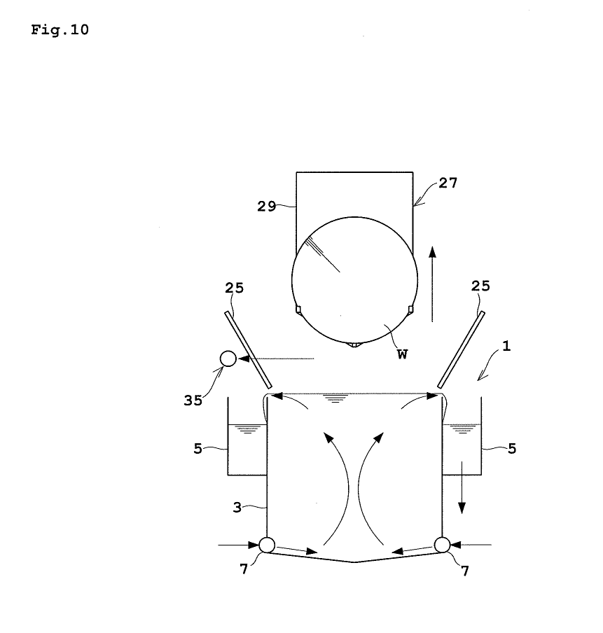

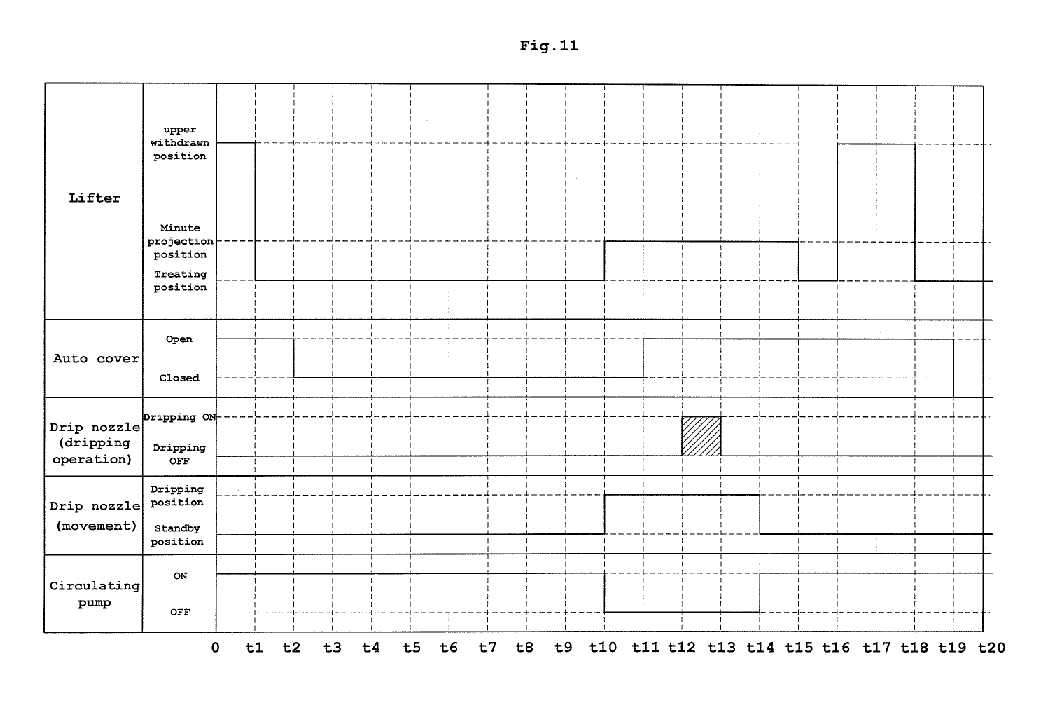

Next, operation by the substrate treating apparatus having the above construction will be described with reference to FIGS. 3 through 10. FIG. 3 is a time chart showing operation of the substrate treating apparatus. FIG. 4 is a schematic view showing a state before treatment. FIG. 5 is a schematic view showing a state during treatment. FIG. 6 is a schematic view showing a state of ascent to a minute projection position. FIG. 7 is an explanatory view of the minute projection position. FIG. 8 is a schematic view showing a dripping state. FIG. 9 is a schematic view illustrating a surface diffusion action. FIG. 10 is a schematic view showing a raising state.

Assume here, as an initial state, that a plurality of wafers W are supported by the lifter 27 in the upper withdrawn position, and that the treating solution already heated to the treatment temperature fills the treating tank 1 and is circulated through the circulation piping 9. This state is shown in FIG. 4.

First, at time t1, the controller 45 lowers the lifter 27 from the upper withdrawn position to the treating position. Subsequently, at time t2, the controller 45 closes the auto cover 25. The wafers W are treated by maintaining this state for a predetermined time. This state is shown in FIG. 5.

The above treatment corresponds to the “treating step” in this invention.

Consequently, for example, the particles adhering to the wafers W separate from the wafers W, to be carried by the flows of the treating solution and discharged to the outer tank 5. However, all the particles are not discharged but part of the particles remain with stagnant flows of the treating solution in the inner tank 3. This state is shown in FIG. 9. Specifically, as shown in FIG. 5, the treating solution fed from the jet pipes 7 turns upward from the central parts of the bottom of the inner tank 3, and pass through spaces between the central parts of the wafers W, to be discharged from the upper edges of the inner tank 3. It is thought that, in the course of the flows of the treating solution, stagnations occur adjacent the surface of the treating solution from the central part toward the upper edges of the inner tank 3. It has been found from experiment conducted by Inventors that the particles stagnate in this area.

Upon lapse of the treatment time at time t10, the controller 45 controls the lift driver 33 to raise the lifter 27 from the treating position to the minute projection position. Further, the controller 45 controls the nozzle driver 41 to move the drip nozzle 35 from the standby position to the dripping position. Along with these operations, the controller 45 stops the circulating pump 13 to stop circulation of the treating solution. This state is shown in FIG. 6.

The above stopping of the lifter 27 corresponds to the “step of stopping ascent of the lifter” in this invention.

The minute projection position here is a position shown in FIG. 7. That is, it is a position where the height of the wafers W projecting from the surface of the treating solution is h. This minute height h is about 0.1-1 mm, for example. The minute height h is adequate as long as it produces a flow straightening action to be described hereinafter, and may therefore be determined as appropriate according to the diameter of wafers W, the type of treating solution and the type of surfactant.

Next, the controller 45 opens the auto cover 25 at time t11. Subsequently, for time t12-t13, the controller 35 causes the drip nozzle 35 to drip the surfactant. FIG. 8 shows this state. The quantity of dripping is 1 cc-500 cc, for example, which may be determined according to the opening area of the inner tank 3, the type of treating solution, and the quantity of stagnant particles.

The above dripping corresponds to the “dripping step” and the “step of dripping” in this invention.

The behavior taking place when the surfactant is dripped is shown in FIG. 9. When the surfactant with low surface tension is dripped to the surface of the treating solution with high surface tension and with particles existing thereon, the surfactant spreads over the surface of the treating solution toward the outer tank 5 by surface diffusion action in a short time. Since the particles move to areas of higher surface tension at this time, the particles are discharged to the outer tank 5. The wafers W, with the upper edges located in the minute projection position h, produce a flow straightening action to move the surfactant in plane directions of the wafers W. Consequently, the particles can be discharged efficiently. Since the surfactant having the above characteristic is dripped, the heat of the treating solution evaporates the surfactant in a short time after the surfactant produces the surface diffusion action. Therefore, the concentration of the treating solution is not affected.

Next, at time t14, the controller 45 moves the drip nozzle 35 to the standby position, and operates the circulating pump 13 to resume circulation of the treating solution through the circulation piping 9. Consequently, the particies discharged to the outer tank 5 are removed by the filter 17. At time t15, the controller 45 raises the lifter 27 to the upper withdrawn position. This completes the treatment of the plurality of wafers W. This state is shown in FIG. 10.

According to the apparatus in this embodiment, as described above, the controller 45 causes the treating solution to be fed to the inner tank 3, and causes the lifter 27 to locate the wafers W in the treating position, to treat the wafers W with the treating solution. Most of the particles thereby separated from the wafers W are discharged from the inner tank 3, but part of the particles remain afloat on the surface of the treating solution. Subsequently, when raising the lifter 27 to the upper withdrawn position, the controller 45 causes the drip nozzle 35 to drip the surfactant to the surface of the treating solution. Consequently, the surfactant produces a surface diffusion action to draw the particles to the areas of higher surface tension and discharge the particles out of the inner tank 3. Subsequently, the wafers W are moved up to the upper withdrawn position from the surface of the treating solution with the particles substantially removed therefrom. This can prevent contamination of the wafers W by the particles afloat on the surface of the treating solution. Since the surfactant is dripped only before raising of the wafers W, the surfactant will hardly affect the treatment with the treating solution, and can lessen variations in the finish.

The drip nozzle 35 has discharge openings 39 formed apart from one another in the lower surface of the nozzle body 37, and when in the dripping position set between the wafers W. Thus, the surfactant can be dripped between the wafers W and to the central parts on the surfaces of the wafers W. Therefore, the surface diffusion action can be produced evenly in areas in which the wafers W are located. As a result, the particles can be discharged evenly from the areas of the wafers W.

The apparatus in this embodiment may operate as follows. Here, reference is made to FIG. 11. FIG. 11 is a time chart showing a modified operation.

The apparatus in the foregoing embodiment drips the surfactant when the lifter 27 is located in the position of minute projection height h, and thereafter raises the lifter 27 to the upper withdrawn position. However, as at time t15-t16 in FIG. 11, the lifter 27 may once be lowered from the minute projection position to the treating position, and may thereafter be raised to the upper withdrawn position. Since the particles on the solution surface have already been discharged at this time, this operation can produce the same effect as the operation described hereinbefore. Since the surfactant is dripped in the minute projection position, there is a possibility that part of the surfactant adheres to the upper edges of the wafers W, or a small part of the particles could adhere to the upper edges of the wafers W at the time of projection. By once returning the wafers W from the minute projection position to the treating position, such adhering substances can be removed, thereby to treat the wafers W with increased cleanliness.

The movement to the minute projection position and the treating position may be carried out not only once but a plurality of times. Consequently, the adhering substances can be removed with increased effect by liquid currents accompanying the vertical movements.

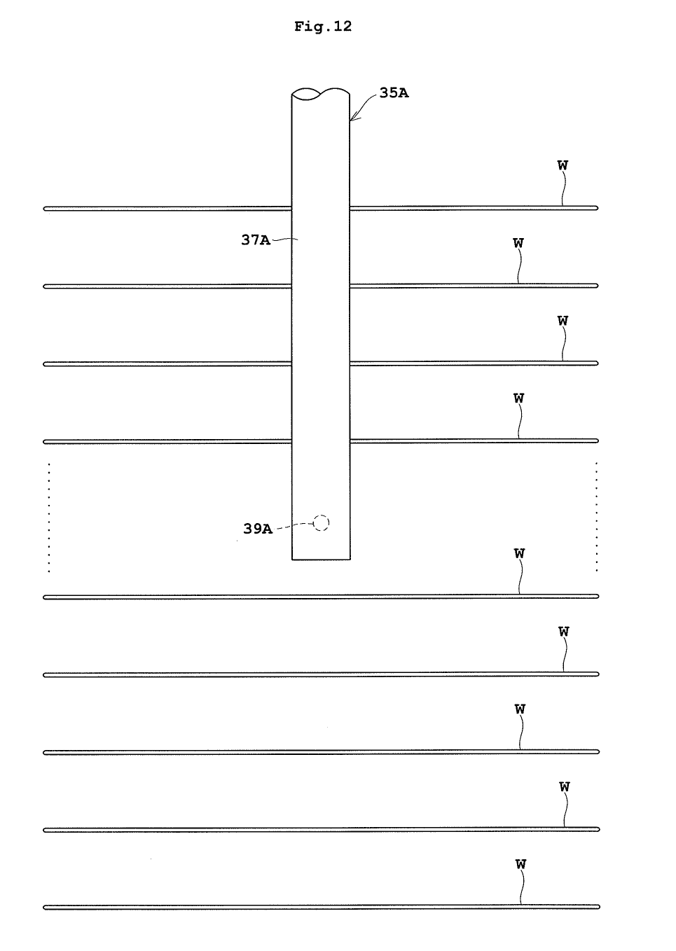

The foregoing drip nozzle 35 may be replaced with the following. Here, reference is made to FIG. 12. FIG. 12 is a plan view showing a modified drip nozzle.

This drip nozzle 35A includes a tubular nozzle body 37A extending to a middle position in the aligning direction of the wafers W and a middle position in the direction perpendicular to the aligning direction of the wafers W, and a discharge opening 39A formed in a lower surface of the nozzle body 37A in the middle position in the aligning direction of the wafers W.

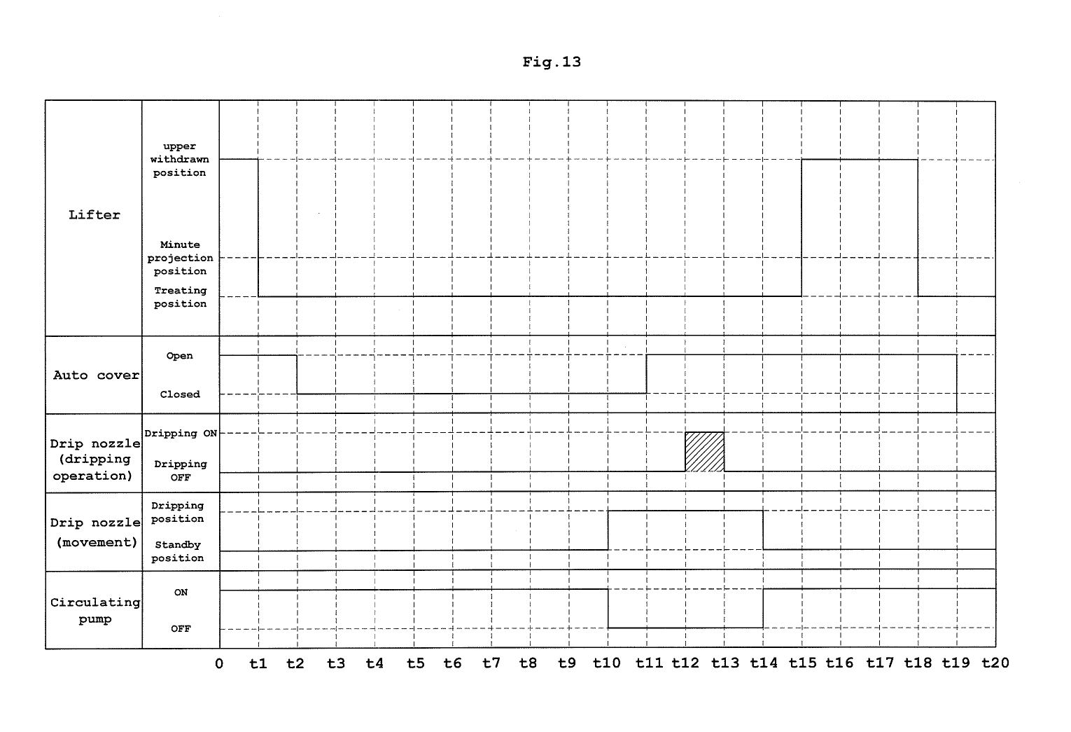

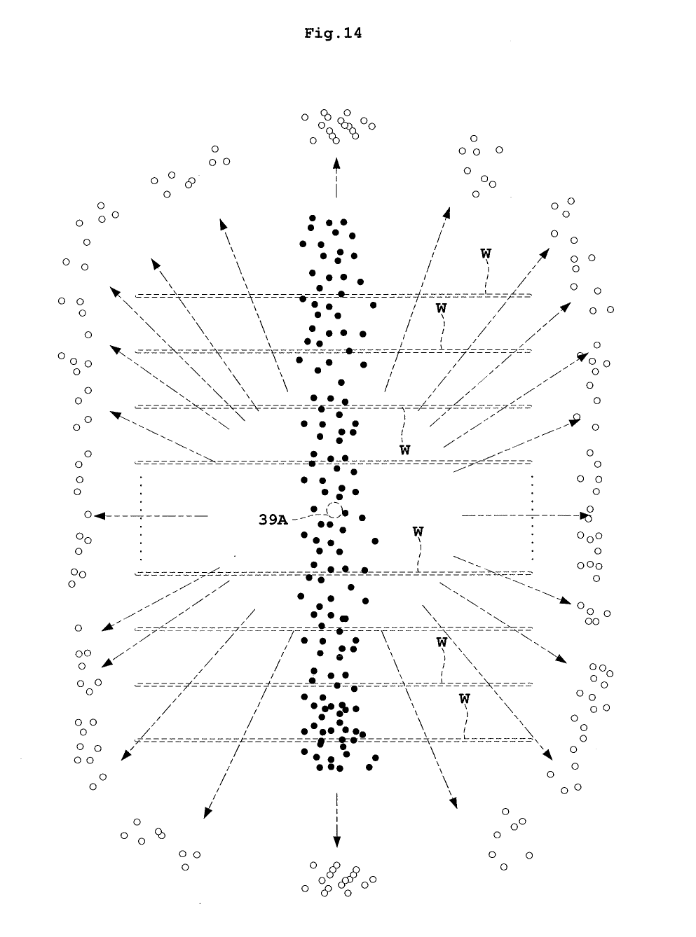

The substrate treating apparatus having such drip nozzle 35A preferably carries out treatment as follows. Here, reference is made to FIGS. 13 and 14. FIG. 13 is a time chart showing operation when the modified drip nozzle is used. FIG. 14 is a schematic view illustrating a surface diffusion action.

The controller 45 moves the lifter 27 from the treating position to the upper withdrawn position at time t15, but before this, at time t12-t13, drips the surfactant from the drip nozzle 35A. This operation results in the surfactant dripping adjacent the central part of the inner tank 3 with the plurality of wafers W present under the surface of the treating solution.

Then, as shown in FIG. 14, the surfactant produces a surface diffusion action in form of concentric circles from the central part of the inner tank 3 in directions of discharge of the treating solution, thereby to discharge the particles afloat on the surface of the treating solution. Thus, this modification produces the same effect as the apparatus in the foregoing embodiment.

This invention is not limited to the foregoing embodiment, but may be modified as follows:

(1) In the foregoing embodiment, the surfactant is dripped onto the surface of the treating solution when the wafers W are moved from the treating position to the upper withdrawn position. Another surfactant having a different characteristic to the surfactant dripped from the drip nozzle 35 or 35A may be mixed into the treating solution. Specifically, just before moving the wafers W to the treating position, this surfactant (first surfactant) is dripped to the outer tank 5, and the surfactant described hereinbefore (second surfactant) is dripped when raising the wafers W. According to this arrangement, the first surfactant can smoothly separate the particles from the wafers W during the treatment with the treating solution, prevent re-adhesion, and also prevent adhesion of the particles at the time of raising of the wafers W.

(2) In the foregoing embodiment, the drip nozzle 35 or 35A is constructed movable between the standby position laterally of the inner tank 3 and the dripping position above the inner tank 3. This invention is not limited to such construction, but may use, for example, a fixed drip nozzle which can drip the surfactant to the position described hereinbefore.

(3) The foregoing embodiment has been described taking treatment of the wafers W which are circular in shape for example. This invention is applicable also to treatment of substrates shaped otherwise.

(4) In the foregoing embodiment, the treating tank 1 consists of the inner tank 3 and outer tank 5. Instead, the treating tank 1 may only have the inner tank 3.

(5) In the foregoing embodiment, treatment is carried out while circulating the treating solution through the circulation piping 9. However, this invention is applicable also to a construction without the circulation piping 9, in which the treating solution overflowing the inner tank 3 is discarded via the outer tank 5 or discarded directly.

This invention may be embodied in other specific forms without departing from the spirit or essential attributes thereof and, accordingly, reference should be made to the appended claims, rather than to the foregoing specification, as indicating the scope of the invention.

What is claimed is:

1. A substrate treating apparatus for treating substrates by immersing the substrates in a treating solution, comprising:
a treating tank for storing the treating solution;
a lifter capable of supporting a plurality of substrates, and vertically movable between an upper withdrawn position above the treating tank and a treating position inside the treating tank;
a treating solution supply device for supplying the treating solution to the treating tank;
a dripping device for dripping a surfactant to a surface of the treating solution stored in the treating tank; and
a control device for causing the treating solution supply device to supply the treating solution to the treating tank, causing the lifter to place the substrates in the treating position, and causing the dripping device to drip the surfactant when raising the lifter to the upper withdrawn position after treatment of the substrates with the treating solution.

2. The substrate treating apparatus according to claim 1 wherein the control device is arranged, after beginning to raise the lifter from the treating position, to stop ascent of the lifter and to cause the dripping device to drip the surfactant when upper edges of the substrates are exposed by a predetermined height from the surface of the treating solution.

3. The substrate treating apparatus according to claim 2 wherein the control device is arranged, after the surfactant is dripped, to lower the lifter to immerse the upper edges of the substrates exposed from the surface of the treating solution, under the surface of the treating solution again, and thereafter to raise the lifter to the upper withdrawn position.

4. The substrate treating apparatus according to claim 1 wherein the control device is arranged to cause the dripping device to drip the surfactant before the lifter is raised to expose upper edges of the substrates from the surface of the treating solution.

5. The substrate treating apparatus according to claim 1 wherein the dripping device includes a nozzle body extending in an aligning direction of the substrates supported by the lifter, and located in central parts of the substrates in a direction perpendicular to the aligning direction, and discharge openings formed in a lower surface of the nozzle body for dripping the surfactant between the substrates.

6. The substrate treating apparatus according to claim 2 wherein the dripping device includes a nozzle body extending in an aligning direction of the substrates supported by the lifter, and located in central parts of the substrates in a direction perpendicular to the aligning direction, and discharge openings formed in a lower surface of the nozzle body for dripping the surfactant between the substrates.

7. The substrate treating apparatus according to claim 3 wherein the dripping device includes a nozzle body extending in an aligning direction of the substrates supported by the lifter, and located in central parts of the substrates in a direction perpendicular to the aligning direction, and discharge openings formed in a lower surface of the nozzle body for dripping the surfactant between the substrates.

8. The substrate treating apparatus according to claim 4 wherein the dripping device includes a nozzle body extending in an aligning direction of the substrates supported by the lifter, and located in central parts of the substrates in a direction perpendicular to the aligning direction, and discharge openings formed in a lower surface of the nozzle body for dripping the surfactant between the substrates.

9. The substrate treating apparatus according to claim 1 wherein the dripping device includes a nozzle body having a discharge opening located centrally of an entire surface of the treating solution stored in the treating tank.

10. The substrate treating apparatus according to claim 1 further comprising a heating device for heating the treating solution;
wherein the dripping device drips the surfactant having a boiling point lower than a temperature of the treating solution heated by the heating device.

11. The substrate treating apparatus according to claim 1 wherein the dripping device drips the surfactant consisting of a straight chain alcohol.

12. A substrate treating method for treating substrates by immersing the substrates in a treating solution, comprising:
a treating step for immersing the substrates in the treating solution by moving a lifter supporting a plurality of substrates from an upper withdrawn position above a treating tank storing the treating solution to a treating position inside the treating tank; and
a dripping step for dripping a surfactant to a surface of the treating solution stored in the treating tank when raising the lifter from the treating position to the upper withdrawn position.

13. The substrate treating method according to claim 12 wherein the dripping step includes a step of stopping ascent of the lifter when upper edges of the substrates raised with the lifter are exposed by a predetermined height from the surface of the treating solution, and a step of dripping the surfactant in such state.

14. The substrate treating method according to claim 13 wherein, after the step of dripping the surfactant, the lifter is lowered to immerse the upper edges of the substrates exposed from the surface of the treating solution, under the surface of the treating solution again, and thereafter a raising step is executed to raise the lifter to the upper withdrawn position.

15. The substrate treating method according to claim 14 wherein the dripping step is executed before the lifter is raised to expose upper edges of the substrates from the surface of the treating solution.

16. The substrate treating method according to claim 12 wherein the dripping step is executed to drip the surfactant to central parts of the substrates in a direction perpendicular to an aligning direction of the substrates, and between the substrates.

17. The substrate treating method according to claim 13 wherein the dripping step is executed to drip the surfactant to central parts of the substrates in a direction perpendicular to an aligning direction of the substrates, and between the substrates.

18. The substrate treating method according to claim 14 wherein the dripping step is executed to drip the surfactant to central parts of the substrates in a direction perpendicular to an aligning direction of the substrates, and between the substrates.

19. The substrate treating method according to claim 15 wherein the dripping step is executed to drip the surfactant to central parts of the substrates in a direction perpendicular to an aligning direction of the substrates, and between the substrates.

20. The substrate treating method according to claim 12 wherein the dripping step is executed to drip the surfactant centrally of an entire surface of the treating solution stored in the treating tank.

21. The substrate treating method according to claim 12 further comprising a heating step for heating the treating solution;
wherein the surfactant has a boiling point lower than a temperature of the treating solution.

22. The substrate treating method according to claim 21 wherein the surfactant is a straight chain alcohol.
